(19) United States
(12) Patent Application Publication
(10) Pub. No.: US 2003/0212982 A1
(43) Pub. Date: Nov. 13, 2003

(54) Message compiler for internationalization of application programs

(75) Inventors: Scott Allen Brooks, Austin, TX (US); Debbie Ann Godwin, Rogers, TX (US); Rodney Eldon Walters, Austin, TX (US)

Correspondence Address: Robert H. Frantz, P.O. Box 23324, Oklahoma City, OK, 73123, US

(73) Assignees: International Business Machines Corporation, Armonk, NY; IBM Corporation

(21) Appl. No.: 10/142,629

(22) Filed: May 9, 2002

(51) Int. Cl. G06F 9/44

(52) U.S. Cl. 717/100

(57) ABSTRACT

A system and method to facilitate development, installation, support and maintenance of international versions of application programs and support tools. Language-specific user interface (UI) messages are placed into a message file which is compiled to produce a message source code file and a message definitions and symbols file. The application source code is modified or originally developed to utilize the functions provided by the message source code file, and a language-specific unified application executable program is created by compiling and linking. This language-specific executable program can then be installed on an end users computer without necessity of installing related resource or message catalog files, and without necessity of properly setting environment variables. Application programs for users in alternate languages are produced by translating the message file, and repeating the compiling and linking steps, without need to modify the application source code.

### CROSS-REFERENCE TO RELATED APPLICATIONS (CLAIMING BENEFIT UNDER 35 U.S.C. 120)

This application is related to U.S. patent application Ser. No. 09/942,552, docket number AUS920010597US1, filed on Aug. 30, 2001, by Debbie Ann Godwin, et al., which is commonly assigned with the present patent application.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

The related U.S. patent application Ser. No. 09/942,552, docket number AUS920010597US1, filed on Aug. 30, 2001, by Debbie Ann Godwin, et al., is hereby incorporated by reference in its entirety including figures.

### BACKGROUND OF THE INVENTION

1. Field of the Invention

This invention is directed to a process for configuring a computer system to run an application program by using message files to properly establish the run environment, and to eliminate the need for a user to install an executable file.

### BACKGROUND OF THE INVENTION

Computers are pervasive in most developed societies today. Personal computers (“PC”), handheld and laptop PC's, use of web browsers and web servers, web-enabled wireless telephones, and personal digital assistants (“PDA”) are prevalent in everyday life in many parts of the world. Almost all of these computing systems run an “operating system”, which facilitates the development, installation, and execution of application programs such as word processors, databases, electronic mail, and web browsers.

Such computing systems have a configurable “run environment”, which includes certain definitions and options (“run environment variables”) for the operating system and application programs which it may execute. One common definition is the language option for the basic operating system messages, such as English, French, Spanish or German. Application programs often use some operating system facilities to help adapt or configure their user interfaces to the “system” language option, but application programs often must provide much of the language-specific user interface functionality themselves.

During the very earliest phases of proliferation of personal computers into non-English speaking societies, application programs were “compiled” or “hard coded” to provide a certain user language interface. As such, a computer program such as a word process developed in the United States which provided an English user interface would not be marketable in a non-English speaking country such as Italy. Instead, an Italian-based software company would offer a word processor with a user interface in Italian. Even dialect differences, such as the differences between U.S. English, and United Kingdom English, could result in the marketplace for a particular application program being restricted, due to such differences as symbols (monetary, time, etc.), punctuation and word spelling.

These limitations also applied to commercial application programs, as well, such as banking and insurance mainframe programs running on mainframe computers.

Some software producers with more extensive development resources would actually provide multiple language versions of the same application program. Typically, the English-based source code would be edited to replace any user interface strings, rule, and checks, with alternate language strings, rules and checks, and the program would be recompiled. As such, if a producer had the resources to do so, five different compiled versions of an application program for five different languages would be offered by the same software producer, for example.

During this time, user installation of an application program and quality control of new versions of each application program were fairly straightforward. During prerelease quality control testing and verification of a particular language version of an application program, only that program would need to be tested in a computing environment of the target language. For example, a French-only version of a word processor could be subjected to a suite of tests while being run on a computer which represents the brand, model and operating system most commonly used in France. There would be very little need to test the French-only version on a computer which was not prevalent in France because the combination of the two would be unlikely in the marketplace.

Likewise, user installation was relatively simple, as a user would not have to correctly select or set run environment variables to select a French interface, French keyboard arrangement, French character and font sets, etc. Instead, a computer purchased in France would already be configured for such an environment, and installation of the French-only word processor application program would assume these configuration issues were already resolved. Thus, computer users enjoyed a relatively short and simple period of simplicity of application program installation and use.

This process of editing and recompiling such a program for a specific market was often referred to as “localization” of that product during this time, including activities such as translating related written materials (e.g. user's manuals, marketing brochures, etc.). FIG. 6 provides an illustration of such a localization process (60), which begins with initial design (61) of an application program in a first or “native” user interface (“UI”) language, followed by compiling (62) that source code into an executable program. Then, the executable program is tested (63) on a set of computer configurations (OS, manufacturer, models, etc.) which are likely to be used in the marketplace(s) where the native language is prevalent. Following successful testing, that native-language version (e.g. English) of the application program is released (64) for installation and sales in that marketplace. If additional markets are to be served by the same product (65), the source code would be edited (65) again to change any UI language-specific code (e.g. menus, error messages, symbol and font sets, punctuation rules, etc.), recompiled (67), tested (68) with a set of likely computer configurations for that alternate-language market, and another language-specific version of the application program would be released (69) for that specific market. If additional markets were to be addressed (602), the editing, recompiling and re-testing cycle would be repeated for each alternate UI language (65 though 69), resulting in the release of a collection of language-specific products (603).

As international markets became more and more intertwined, and as modular and object-oriented programming techniques became the typical programming methodology, these market-dependent variables and options became modularized as well. For example, a typical word processor application program does not consist of just a single executable program, but comprises hundreds or even thousands of components, modules, and dynamic linked libraries (DLL's). The source code for these application programs is likewise highly modularized, often comprising collections of literally thousands of source code files. Theoretically, this promotes code “reuse” so that areas or components of logic which are not language dependent can be developed and maintained separately from code which is language dependent. This philosophy applies also to code which is or is not dependent on the operating system of the computer platform, the printer installed with the computer, the protocol of the communications network to which the computer is interfaced, etc.

This process, then, adopts a design architecture and arrangement with a view towards use of each application program in a wide variety of user language environments from the earliest phases of design, rather than adapting the program to various localities after it has been design initially for a single environment. This approach is often referred to as “internationalization” of products, wherein they are originally designed with the intent and capability of being deployed, sold or marketed in a wide variety of international marketplaces.

One benefit of this modular approach has been to allow application program producers to maximize their marketplaces by placing certain market-related code and information in separately developed an maintained modules or DLLs. For example, separate files which define a network protocol used only in France would be installed only if the application program were to be run in a French run environment.

As for user interfaces and their text messages provided to users, some software producers have attempted to move these run environment definitions and information into “resource files” and “initialization” files. The Microsoft Visual C++ compiler uses a method called a “resource compiler”, for example. The programmer places all of the language-specific messages inside a resource file that is then compiled by the resource compiler into an object file. The object file is eventually linked into the executable program. If the software requires internationalization, the resource file is edited by a translator, the resource file is recompiled, and the software is relinked. The Microsoft Win32 Software Development Kit (“SDK”) also provides a resource compiler similar to the one that is provided with Visual C++. Using either resource compiler, however, produces code which is highly coupled to the Microsoft operating systems such that it only executes on computers running Microsoft operating systems, and not all features common to all C++ development environments are supported.

Another attempt to resolve or reduce these problems and shortcomings of the present design, test, installation and support methods in the art was developed by IBM for internationalization of support tools using a “message catalog”. A message catalog was defined which contained all the language-specific code or text, such as error messages, user prompts, menu items, etc. FIG. 3 shows the process of internationalization of a software application program or support tool according to this process (30).

Several message catalog files (31a, 31b, and 31c) containing language-specific information could be processed by a utility called “gencat” (33), which yielded a C header file (*.h) (34a, 34b, and 34c), each for a specific UI language. Common application source code (32) modules such as C++(*.cpp) and other header files would then be compiled, language-specific object files (37a, 36b, and 37c), which would then be linked into one multi-language application program (39). This multi-language application program (39) however does not contain the actual content of the message catalogs, but rather is provided with references to the contents of the message catalogs (31a, 31b, and 31c).

To install a specific UI language version (300, 301, 302) or configuration of the application program, the multi-language application program (39) would be installed on the computer along with the message file (36a, 36b, or 36c), and the application program (39) would use a system environment variable (EV) (350) to find the location of the message file (36a, 36b, or 36c) in order to access and produce user interface messages. If the environment variable (350) is missing or incorrectly defined on a particular end user's computer, the application program (39) will be unable to produce messages to the user, thus causing a need for support and intervention from the software provider.

For end users to use IBM application programs utilizing a full message catalog, the user's environment variables still had to be properly set on the user's system to run the application. For simple applications, the support overhead of getting the users to correctly set up their environment was a draw back to using the otherwise easy-to-use support tools. As such, this approach solved some of the problems in the art, namely the problems of developing multiple versions of an application, but not all the problems (e.g. installation and support issues).

In the broader market, sophisticated installation programs (e.g. installation “wizards”) have been developed which attempt to determine exactly which resource files, message catalogs, DLLs, and initialization file options to install and set based upon examination of other options already set on a computer, and through query of the user. In many cases, the user is not fully cognizant of the ramifications of certain selections with which he or she may be presented during installation of an application program, which may result in partially incorrect installation of the application program, its components and options. Hundreds or even thousands of installation choices may be made by the installation wizard during the install process, resulting in many possible problems based upon incorrect determination of which components to install and which environment variables to set. This has led to increased customer difficulties and frustration, and to significantly increased costs of user support to the software producers.

Further, the quality control processes of such highly modularized program architectures has become unwieldy and unrealistic. Reasonable assumptions as to the computing platform environment and user interface options can no longer be made in order to reduce a test suite to a realistic magnitude of combinations. For example, just about any personal computer and operating system can be configured through installation choices and environment variables to provide one of many user interface languages, and just about any application program can be configured during installation to provide a matching language user interface. So, if a particular word processor application program supports 10 different user interface languages and it is to be thoroughly tested on a range of computer platforms which also support those 10 languages, at minimum 100 combinations of installation must be verified for a full suite of functionality. Compounding this problem is that most international markets enjoy multiple versions of multiple operating systems, as well, such as Microsoft's Windows [TM] (e.g. Windows 6.1, 95, 98, 2000, NT, ME, etc.), Apple's MacOS [TM] (e.g. OS 4, 5, 6, 8, etc.), and a countless number of variants of Unix and Linux.

As such, to fully test a new release of an application program, there may be millions of combinations of hardware, software, driver, and operating system variations to be tested. This, of course, is not economically feasible in the software industry, and so most programs are tested and verified in substantially reduced sets of combinations of these environments. Consequently, users of computers have become accustomed to having a number of configuration problems following installation of a new application program, or following an “upgrade” of an existing application program.

However, given today's software development methodologies and tools, it is not economically feasible to adopt more stringent quality control processes, or to return to the monolithic code architectures of the early days of consumer software production.

Therefore, there is a need in the art for a system and method which both allows modular and object-oriented code development in order to take benefit of the development efficiencies of these methodologies, and which allows for simplified, unified application program delivery and installation on computing platforms which minimizes dependencies on properly installed components, modules, and environment variables.

### BRIEF DESCRIPTION OF THE DRAWINGS

The following detailed description when taken in conjunction with the figures presented herein provide a complete disclosure of the invention.

FIG. 1 depicts a generalized computing platform architecture, such as a personal computer, server computer, personal digital assistant, web-enabled wireless telephone, or other processor-based device.

FIG. 2 shows a generalized organization of software and firmware associated with the generalized architecture of FIG. 1.

FIG. 3 illustrates one method currently in use to internationalize application and tool programs.

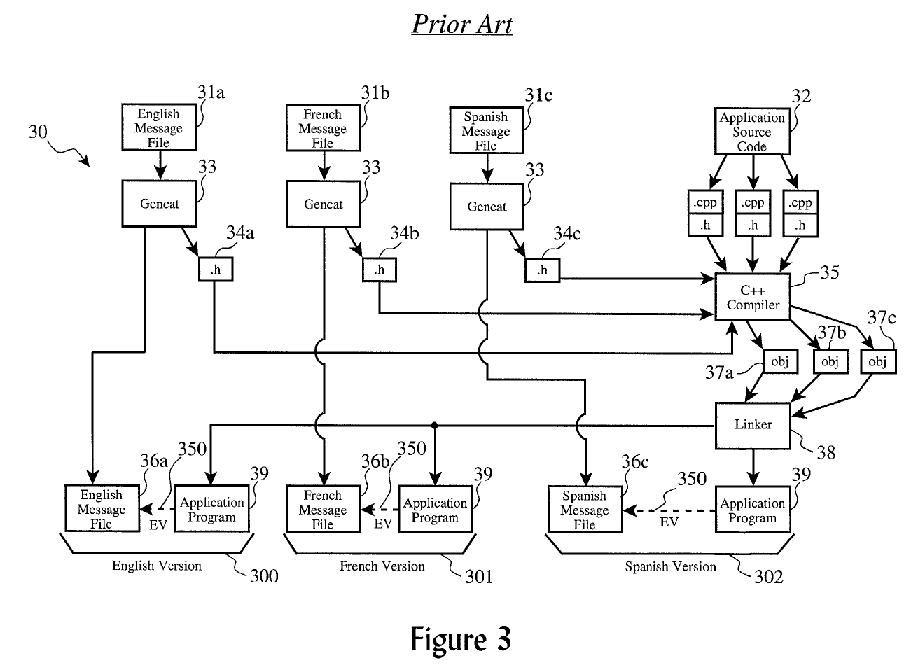

FIG. 4 shows the process of the invention to create an initial, single-language version of an application program or tool program.

FIG. 5 sets forth an example of the method of the invention to produce three different language-specific versions of the same application program or support tool.

FIG. 6 provides and illustration of a well-known process of localization for an application program or support tool.

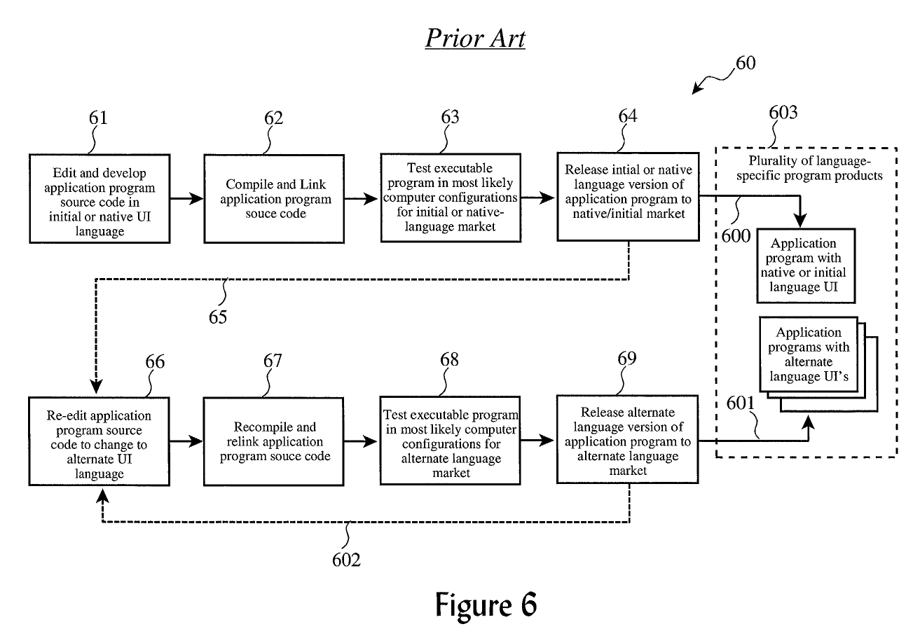

### SUMMARY OF THE INVENTION

A system and method is disclosed which uses the same message or resource files as would the modularized and object-oriented systems and methods of the prior art, but which produces language-specific unified executable files which do not dependent on a multitude of environment variables, settings, and related module installations to operate properly.

According to our preferred embodiment, our message compiler tool accepts a message file in a format which is compatible with the existing IBM internationalization tool “gencat”, and creates C++*.cpp and *.h source files from these message files. These message source files are compiled into an C++ object module, which is later linked with tool or application-specific code to produce a unified, user interface language-specific executable tool or application program. This unified executable program contains the actual information for the language specific messages (e.g. prompts, menu items, error messages, etc.), such that when installed on a users computer, no special environment variables have to be set and no related modules (e.g. DLLs, resource files, etc.) have to be installed.

In general, to develop an application using the message compiler invention, the software developer follows these steps:

1. creates a basic message file such as “my_msg.msg”;

2. executes the message compiler by invoking it as such:

msgcomp my_msg.msg=>my_msg.cpp+my_msgs.h;

3. includes the message compiler output such as “my_msgs.h” in the application or tool source code whenever it is necessary to use the language-specific messages;

4. compiles the message source code such as “my_msgs.cpp” with rest of the application source code to produce object modules; and

5. links the object modules to produce the language-specific executable program.

To change user interface languages, the messages and prompts in the message file such as “my_mgs.msg” are translated into the desired language, and steps 1 through 5 are repeated, without necessity to edit the application source code.

This yields the following advantages in the process, installation and support of these applications:

(a) modular and object-oriented programming methodologies are used, which inherits all the benefits of code reuse and team development;

(b) a full set of C and C++ functions are supported, eliminating dependencies on specific operating systems for running the application program;

(c) unified, language-specific application programs are created which are easier test in a reduced set of anticipated computing environments; and

(d) unified, language-specific application programs are created which are easier for a user to install, without a need for correctly installing language-specific resource files and setting environment variables.

Unlike the existing resource compiler and the Win32 Software Development Kit, our new method and process uses features common to all C++ development environments such that the resulting code can be compiled for any platform that provides a C++ development environment, regardless of whether it is running a Microsoft or other operating system.

### DETAILED DESCRIPTION OF THE INVENTION

The present invention is preferably realized as a feature or addition to the software already found present on well-known computing platforms such as personal computers and software development workstations. These common computing platforms can conceivably include portable computing platforms, such as personal digital assistants (“PDA”), web-enabled wireless telephones, and other types of personal information management (“PIM”) devices, as well.

Therefore, it is useful to review a generalized architecture of a computing platform which may span the range of implementation, from a high-end web or enterprise server platform, to a personal computer, to a portable PDA or web-enabled wireless phone.

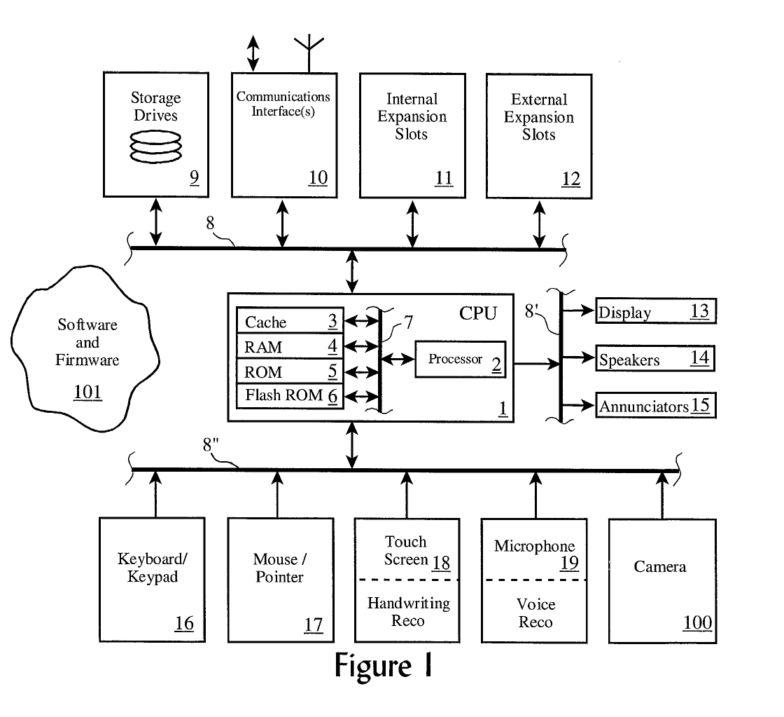

Turning to FIG. 1, a generalized architecture is presented including a central processing unit (1) (“CPU”), which is typically comprised of a microprocessor (2) associated with random access memory (“RAM”) (4) and read-only memory (“ROM”) (5). Often, the CPU (1) is also provided with cache memory (3) and programmable FlashROM (6). The interface (7) between the microprocessor (2) and the various types of CPU memory is often referred to as a “local bus”, but also may be a more generic or industry standard bus.

Many computing platforms are also provided with one or more storage drives (9), such as a hard-disk drives (“HDD”), floppy disk drives, compact disc drives (CD, CD-R, CD-RW, DVD, DVD-R, etc.), and proprietary disk and tape drives (e.g., lomega Zip [TM] and Jaz [TM], Addonics SuperDisk [TM], etc.). Additionally, some storage drives may be accessible over a computer network.

Many computing platforms are provided with one or more communication interfaces (10), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (IrDA) interface, too.

Computing platforms are often equipped with one or more internal expansion slots (11), such as Industry Standard Architecture (ISA), Enhanced Industry Standard Architecture (EISA), Peripheral Component Interconnect (PCI), or proprietary interface slots for the addition of other hardware, such as sound cards, memory boards, and graphics accelerators.

Additionally, many units, such as laptop computers and PDA's, are provided with one or more external expansion slots (12) allowing the user the ability to easily install and remove hardware expansion devices, such as PCMCIA cards, SmartMedia cards, and various proprietary modules such as removable hard drives, CD drives, and floppy drives.

Often, the storage drives (9), communication interfaces (10), internal expansion slots (11) and external expansion slots (12) are interconnected with the CPU (1) via a standard or industry open bus architecture (8), such as ISA, EISA, or PCI. In many cases, the bus (8) may be of a proprietary design.

A computing platform is usually provided with one or more user input devices, such as a keyboard or a keypad (16), and mouse or pointer device (17), and/or a touch-screen display (18). In the case of a personal computer, a full size keyboard is often provided along with a mouse or pointer device, such as a track ball or TrackPoint [TM]. In the case of a web-enabled wireless telephone, a simple keypad may be provided with one or more function-specific keys. In the case of a PDA, a touch-screen (18) is usually provided, often with handwriting recognition capabilities.

Additionally, a microphone (19), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (100), such as a still digital camera or full motion video digital camera.

One or more user output devices, such as a display (13), are also provided with most computing platforms. The display (13) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (14) and/or annunciators (15) are often associated with computing platforms, too. The speakers (14) may be used to reproduce audio and music, such as the speaker of a wireless telephone or the speakers of a personal computer. Annunciators (15) may take the form of simple beep emitters or buzzers, commonly found on certain devices such as PDAs and PIMs.

These user input and output devices may be directly interconnected (8′, 8″) to the CPU (1) via a proprietary bus structure and/or interfaces, or they may be interconnected through one or more industry open buses such as ISA, EISA, PCI, etc.

The computing platform is also provided with one or more software and firmware (101) programs to implement the desired functionality of the computing platforms.

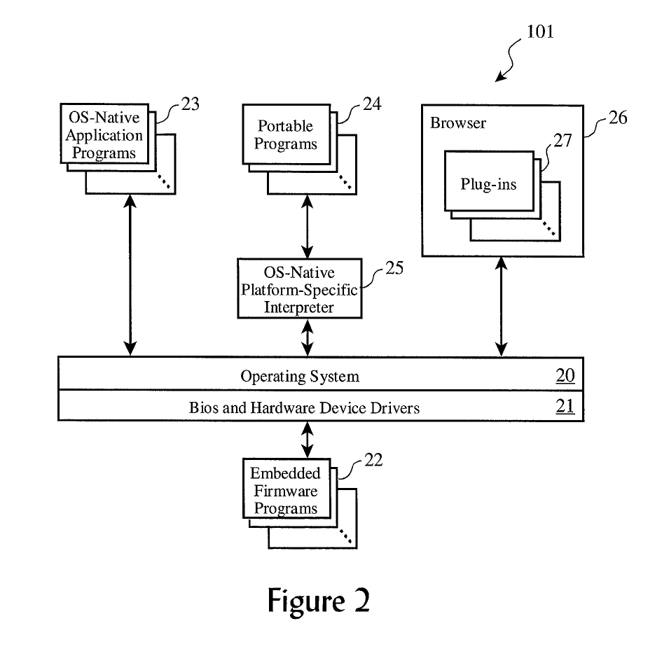

Turning to now FIG. 2, more detail is given of a generalized organization of software and firmware (101) on this range of computing platforms. One or more operating system (“OS”) native application programs (23) may be provided on the computing platform, such as word processors, spreadsheets, contact management utilities, address book, calendar, email client, presentation, financial and bookkeeping programs.

Additionally, one or more “portable” or device-independent programs (24) may be provided, which must be interpreted by an OS-native platform-specific interpreter (25), such as Java [TM] scripts and programs.

Often, computing platforms are also provided with a form of web browser or microbrowser (26), which may also include one or more extensions to the browser such as browser plug-ins (27).

The computing device is often provided with an operating system (20), such as Microsoft Windows [TM], UNIX, IBM OS/2 [TM], LINUX, MAC OS [TM] or other platform specific operating systems. Smaller devices such as PDA's and wireless telephones may be equipped with other forms of operating systems such as real-time operating systems (“RTOS”) or Palm Computing's PalmOS [TM].

A set of basic input and output functions (“BIOS”) and hardware device drivers (21) are often provided to allow the operating system (20) and programs to interface to and control the specific hardware functions provided with the computing platform.

Additionally, one or more embedded firmware programs (22) are commonly provided with many computing platforms, which are executed by onboard or “embedded” microprocessors as part of the peripheral device, such as a micro controller or a hard drive, a communication processor, network interface card, or sound or graphics card.

As such, FIGS. 1 and 2 describe in a general sense the various hardware components, software and firmware programs of a wide variety of computing platforms, including but not limited to personal computers, PDAs, PIMs, web-enabled telephones, and other appliances such as WebTV [TM] units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

We now turn our attention to description of the method of the invention and it's associated components. It is preferrably realized as a standalone executable program developed in C++, but may equally well be implemented in other programming languages and methodologies. The message compiler program accesses and modifies certain system files and resources as described in more detail in the following paragraphs, but may well be integrated into existing software such as software compilers and development kits without departing from the spirit and scope of the invention.

By using the method and tool of the invention in the preferred embodiment, a software programmer can specify messages by using C++ symbols, and the language translator can concentrate on a message file that does not contain any programming code whatsoever. Further, the end user only has one file, the executable, to get installed correctly and to maintain. As such, there is little chance of someone in the process changing the messages and corrupting an external text file, which is especially important for certain applications such as security and administration tools.

The message file can also be defined to contain double byte text formats in order to accommodate languages that do not use a Latin alphabet, such as Asian languages that require very large numbers of symbols and characters.

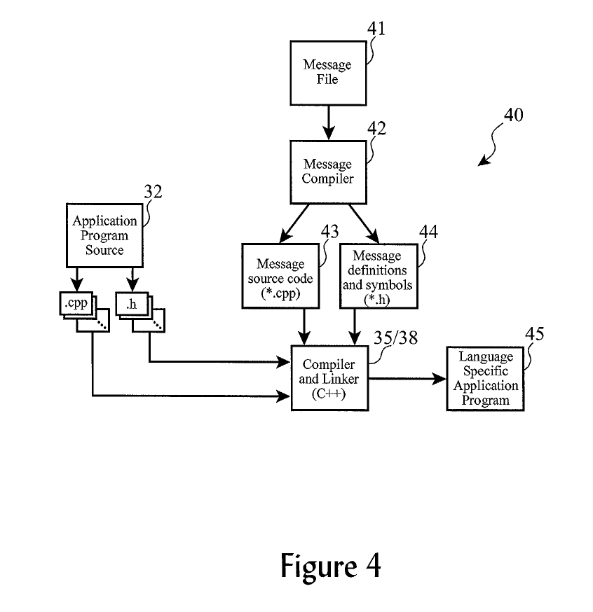

Turning now to FIG. 4, the general process of the invention is shown. The developer starts the process by creating a message file (41) using a text editor. If the developer wants to support Asian or double-byte languages, a text editor capable of creating double byte text should be employed for this step.

The message text file (41) preferrably consists of two columns separated by a column delimiter, and multiple rows separated by a row delimiter. Common delimiter schemes, such as commas or tabs for the column delimiters and hard carriage returns and end-of-line characters for the row delimiters, can be used, as shown in Table 1. One column contains a name that is consistent with the rules for creating C++ symbols, and the other column contains the actual language-specific message written in the programmer's native or initial language.

TABLE 1
Example English Message Text File

| | |
|---|---|
| msg1 | “Welcome to ABC Bank Tellers System” |
| err1 | “Error: Please Log In First” |
| menu1 | “F1 = Open Account, F2 = Close Account, |
| | F3 = Change Acct” |
| menuF1a | “Open Account Options: (1) Create new acct, |
| | (2) Convert acct” |
| . | . |
| . | . |
| . | . |

In this example, four messages are shown, with the names of “msg1”, “err1” “menu1” and “menuF1a”, for banking teller application. The native language, in this case, is shown to be U.S. English. Table 2 shows an example text message file for the same application program in German. Note that the message names are maintained between the various translations of the message text files, but the order of the messages in the file do not have to be the same.

TABLE 2
Example German Message Text File

| | |
|---|---|
| err1 | “Fehlermeldung. Einloggen Sie, bitte.” |
| msg1 | “Wilkommen auf ABC Bankangestellte Programm” |
| menuF1a | “Bankkonto Aufmachen Wahl: (1) Machen neu Bankkonto; |
| | (2) Konvertieren Bankkonto” |
| menu1 | “F1 = Aufmachen ein Bankkonto, F2 = Zumachen ein |
| | Bankkonto, F3 = Verändern ein Bankkonto” |
| . | . |
| . | . |
| . | . |

If desired, the message file can be of a format which is compatible with previous message and resource files, such as IBM's message catalog files (*.cat) and Microsoft's system resource files.

Next, our message compiler (42) utility program is executed on the message file(s) (41). Preferably, the message compiler is a program which was developed also in C++, but it can alternately be developed in any other suitable programming language and methodology. The message compiler takes the message file and creates two output files:

(a) a message source code file (43); and

(b) a message definition and symbols file (44).

According to the preferred embodiment for a C++ programming environment, the message source code file (43) is a normal C++(*.cpp) file, and the message definition and symbols file (44) is a C++ header (*.h) file.

The message source code file (43) contains source code, such as C++ code, that describes the implementation portion of an object, including functions that can be called to retrieve the messages.

The message definition and symbols file (44) contains a description of the object, and definition statements that define the symbols that were placed into the first column of the message file (41) (e.g. the text message names). These definition statements allow the programmer to write application program source code (32) that will retrieve the messages.

When the developer runs the message compiler (42) using the message file as input, the .cpp and .h files are generated, and the developer then writes the tool or application program source code (32). Each time access to a message is needed within the application program source code, the developer simply includes C++ code that will call the object module created by the message compiler.

Finally, the developer compiles his tool or application program source code (32), and links (38) it with the message source objects, thus creating a single, unified program that will communicate to the user using the language included in the message file (41) without the need for additional message files, resource files, DLLs, or environment variables on the end user's computer.

At this point, a translator can copy the message file (41) to a new file name, and then edit it with a text editor to translate each message to an alternate language. The developer can subsequently compile and link a new language-specific executable application program or tool, as needed. This process can then be repeated for each language that will be supported.

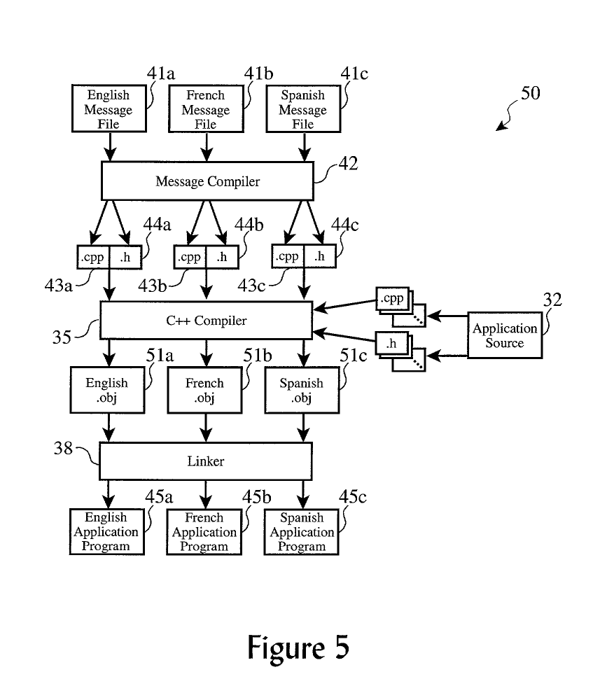

Turning to FIG. 5, the method (50) of the invention as performed to generate three different language-specific versions of a single application program or tool. First, the developer creates a message file as previously described in his or her own native language, such as the English message file (41a). Then, bilingual translators can create translated versions of this first message file, such as a French message file (41b) and a Spanish message file (41c). Herein lies one of the key advantages of the invention: the translator does not have to have any programming skills as the message files contain no programming statements or syntax—they are simply two-column text files.

Then, the developer can invoke the message compiler (42) as previously described to create a message source file and a definitions and descriptions file (43a/44a, 43b/44b, 43c/44c) for each language message file (41a, 41b, 41c), respectively.

Then, language-specific object files (51a, 51b, and 51c) and the application or tool source code (32) are compiled and linked (35/38) using a standard C++ compiler and linker to yield three language-specific application programs (45a, 45b, 45c). These independent, language-specific application programs can then be tested and distributed as needed to various markets.

When one of them is installed on an end user's computer, no additional resource or message files need be installed, and no environment variables must be set to allow it to run correctly, thereby easing installation for the user and reducing the amount of support necessary to complete the installation.

For an example implementation consistent with the preferred embodiment, we now refer to the support tool of the related and incorporated patent application. The invention has been implemented into an IBM security tool called “Loglooker.” Loglooker is an intrusion detection utility that checks networked computer system logs for signs of security intrusions and systematic attacks. Since Loglooker is distributed to IBM personnel all over the world it, must have the capability to support many different languages. However, as it is not a product that directly generates revenues or sales, it did not necessarily meet the threshold to justify extensive development and maintenance support to “internationalize” it using the traditional methods as previously described in the “Background of the Invention”.

Thus, the message compiler of the present invention was developed. An older version of Loglooker already existed. The old version used the aforementioned IBM “gencat” utility and a message catalog file. The message catalog file had to be installed with the older Loglooker tool executable program, and an environment variable had to be correctly set in order for the user to have a complete, functional usable copy of Loglooker.

Because the message compiler was implemented in such a way that the existing English message catalog file could be used as the message file, the message compiler was designed to simply ignore any other fields that did not apply. This was fairly trivial since the message catalog file already defined symbols and messages in the first two columns of the file. As such, the message compiler was run on the existing message catalog file, to produce the new message source code file (*.cpp) and descriptions and definitions file (*.h).

The main source code for Loglooker was rewritten in order to make use of the new C++ objects defined in the message source code file that was created by the message compiler, and the Loglooker tool was re-compiled and re-linked to create a new, English-specific version of Loglooker that is all contained in a single executable. This new Loglooker executable program could then be installed on any system and run successfully, without the need for the older message catalog file or the setting of an environment variable.

When any other languages are needed for the Loglooker user interface, the older message file (e.g. the message catalog file) may be simply translated, followed by running the message compiler on the new message file and recompiling and relinking to create another language-specific version of Loglooker.

As such, the invention provides “the best of two worlds”. In one sense, it provides the easier to test and easier to install, single language-specific executable which does not need a large number of support files and correct settings of environment variables. In another sense, it allows the more advanced and preferable modular and object-oriented design methodologies to be followed, without the usual creation of application programs which are broken into a multitude of related executable files (e.g. DLLs, resource files, etc.) which need environment variables to find each other.

While a number of examples have been given to illustrate the use of the invention and a preferred embodiment, it will be readily apparent to those skilled in the art that certain variations can be made to the method and system without departing from the spirit and scope of the present invention, including but not limited to use of alternate programming languages, computing platforms, operating systems, and methodologies. Therefore, the scope of the invention should be determined by the following claims.

What is claimed is:

1. A method of internationalizing a application program product comprising the steps of:
providing at least one user interface (UI) language-specific message file;
compiling with a message file compiler said UI language message file to produce a UI language-specific message source file and a UI language-specific definitions and symbols file;
creating or modifying common application source code to utilize objects defined by said UI language-specific message source file and a UI language-specific definitions and symbols file; and
compiling and linking said common application source code with said UI language-specific message source file and a UI language-specific definitions and symbols file to yield a unified user interface language-specific application program.

2. The method as set forth in claim 1 wherein said step of providing at least one user interface language-specific message file comprises providing a text file having two columns in each row, one column in a row defining a name for a message contained in the other column of each row.

3. The method as set forth in claim 1 wherein said step of providing at least one user interface language-specific message file comprises providing an IBM message catalog file.

4. The method as set forth in claim 1 wherein said step of providing at least one user interface language-specific message file comprises providing an operating system resource file.

5. The method as set forth in claim 1 wherein said step of compiling said user interface language-specific message file comprises creating a C++ source code file and a C++ header file.

6. A computer readable medium encoded with software for internationalizing a application program product, said software causing a computing platform to perform the steps of:
providing at least one user interface (UI) language-specific message file;
compiling with a message file compiler said UI language message file to produce a UI language-specific message source file and a UI language-specific definitions and symbols file;
creating or modifying common application source code to utilize objects defined by said UI language-specific message source file and a UI language-specific definitions and symbols file; and
compiling and linking said common application source code with said UI language-specific message source file and a UI language-specific definitions and symbols file to yield a unified user interface language-specific application program.

7. The computer readable medium as set forth in claim 6 wherein said software for providing at least one user interface language-specific message file comprises software for providing a text file having two columns in each row, one column in a row defining a name for a message contained in the other column of each row.

8. The computer readable medium as set forth in claim 6 wherein said software for providing at least one user interface language-specific message file comprises software for providing an IBM message catalog file.

9. The computer readable medium as set forth in claim 6 wherein said software for providing at least one user interface language-specific message file comprises software for providing an operating system resource file.

10. The computer readable medium as set forth in claim 6 wherein said software for compiling said user interface language-specific message file comprises software for creating a C++ source code file and a C++ header file.

11. A system for producing internationalized versions of application program products comprising:
at least one user interface (UI) language-specific message file in which message strings and objects are associated with message names;
a message file compiler adapted to compile said UI language message file to produce a UI language-specific message source file and a UI language-specific definitions and symbols file;
a means for editing, creating or modifying common application source code to utilize objects defined by said UI language-specific message source file and a UI language-specific definitions and symbols file; and
a compiler and linker for compiling and linking said common application source code with said UI language-specific message source file and a UI language-specific definitions and symbols file to yield a unified user interface language-specific application program.

12. The system as set forth in claim 11 wherein said user interface language-specific message file comprises a text file having two columns in each row, one column in a row defining a name for a message contained in the other column of each row.

13. The system as set forth in claim 12 wherein said user interface language-specific message file comprises providing an IBM message catalog file.

14. The system as set forth in claim 11 wherein said user interface language-specific message file comprises providing an operating system resource file.

15. The system as set forth in claim 11 wherein said message file compiler is adapted to create a C++ message source code file and a corresponding C++ header file.
